(19) United States
(12) Patent Application Publication
(10) Pub. No.: US 2012/0096699 A1
(43) Pub. Date: Apr. 26, 2012

(54) ATTACHMENT-ENABLING JIG

(75) Inventors: FLY HE, JIANGSU PROVINCE (CN); CHING-FENG HSIEH, TAIPEI CITY (TW)

(73) Assignee: ASKEY COMPUTER CORP., TAIPEI (TW)

(21) Appl. No.: 12/958,441

(22) Filed: Dec. 2, 2010

(30) Foreign Application Priority Data
Oct. 22, 2010 (TW) 099136151

(51) Int. Cl. B23P 19/04

(52) U.S. Cl. 29/428

(57) ABSTRACT

An attachment-enabling jig for attaching a soft strip to an attachment surface of an object quickly, precisely, and flatly includes a base; a first carrying unit disposed on the base and provided with a first roller oriented perpendicular to a first direction; a second carrying unit disposed on the base and provided with a second roller corresponding in position to the first roller, wherein the first and second carrying units carry the soft strip; a resilient unit connected to the first and second carrying units; and an actuating unit disposed on the base and configured to hold the object and controllably drive the attachment surface of the object to move to between the first roller and the second roller such that the first and second rollers attach the soft strip to the attachment surface. Accordingly, the attachment-enabling jig is effective in enhancing the efficiency of production lines.

### CROSS-REFERENCE TO RELATED APPLICATION

This non-provisional application claims priority under 35 U.S.C. §119(a) on Patent Application No(s). 099136151 filed in Taiwan, R.O.C. on Oct. 22, 2010, the entire contents of which are hereby incorporated by reference.

### FIELD OF THE TECHNOLOGY

The present invention relates to attachment-enabling jigs, and more particularly, to an attachment-enabling jig for attaching a soft strip to an attachment surface of an object quickly, precisely, and flatly.

### BACKGROUND

Electronic or mechanical products are indispensable to human beings' daily life nowadays. The use of an electronic or mechanical product is not limited to the product proper; instead, it is not uncommon for various strip-like materials to be attached to the surfaces of different portions of the product as needed. For example, colored strips are attached to an attachment surface of a product to enhance the overall artistic beauty of the product. For example, protective strips are attached to an attachment surface of a product for protecting the attachment surface of the product against damage which might otherwise be caused by an external force. For example, rubber strips are attached to an attachment surface of a product for increasing the friction of the attachment surface or altering the tactile quality of the attachment surface.

Referring to FIG. 1 and FIG. 2, there are shown schematic views of a conventional means of attaching a soft strip 1 to an attachment surface 21 of an object 2. As shown in the drawings, to attach the soft strip 1 to the attachment surface 21 of the object 2, it is necessary to hold the object 2 and the soft strip 1 manually, align the soft strip 1 with the attachment surface 21 of the object 2 manually, and attach the soft strip 1 to the attachment surface 21 of the object 2 manually. The conventional means of attaching the soft strip 1 to the attachment surface 21 of the object 2 manually has its own drawbacks. First, since the attaching process entails holding the object 2 and the soft strip 1 manually, it is not uncommon for the object 2 to be difficult to grip due to its special shape. Second, since the attaching process requires manual alignment, errors in the manual alignment are inevitable but correctable largely by a time-consuming laborious redo. Thirdly, with the attaching process being performed manually, the attaching process sometimes ends up in uneven attachment or generation of bubbles to thereby compromise the artistic beauty of the object 2 or even deteriorate the conforming rate thereof. Fourthly, with the attaching process being performed manually, it is not uncommon for the soft strip 1 to be overstretched or undersupplied because of uneven distribution of a force applied to the soft strip 1 during the attaching process; as a result, the soft strip 1 covers the attachment area excessively or inadequately to thereby compromise the artistic beauty of the object 2 or even deteriorate the conforming rate thereof.

Accordingly, it is imperative to provide a jig for positioning an object and a soft strip and attaching the soft strip to an attachment surface of the object quickly, precisely, and flatly.

### SUMMARY

In view of the drawbacks of the prior art, it is an objective of the present invention to provide an attachment-enabling jig for attaching a soft strip to an attachment surface of an object quickly, precisely, and flatly.

In order to achieve the above and other objectives, the present invention provides an attachment-enabling jig for attaching a soft strip to an attachment surface of an object. The attachment-enabling jig comprises: a base; a first carrying unit disposed on the base, movable across the base in a first direction, and provided with a first roller oriented perpendicular to the first direction; a second carrying unit disposed on the base in a manner that the second carrying unit corresponds in position to the first carrying unit and is positioned proximate to the first roller, the second carrying unit being provided with a second roller corresponding in position to the first roller, the second carrying unit being movable across the base in the first direction, wherein the second carrying unit and the first carrying unit together carry the soft strip; a resilient unit configured to connect the first carrying unit and the second carrying unit and exert, in the first direction, a resilient restoring force upon the first carrying unit and the second carrying unit; and an actuating unit disposed on the base for holding the object above the first roller and the second roller in a manner that the attachment surface faces the first roller and the second roller, and enabling the object to move to between the first roller and the second roller so as for the attachment surface to be positioned between the first roller and the second roller, such that a force from the object and the resilient restoring force from the resilient unit are exerted upon the first carrying unit and the second carrying unit to thereby cause the first carrying unit and the second carrying unit to move relative to each other in the first direction, wherein the first roller and the second roller together attach the soft strip to the attachment surface flatly.

Accordingly, the attachment-enabling jig of the present invention is effective in positioning an object and a soft strip and attaching the soft strip to an attachment surface of the object quickly, precisely, and flatly.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 (PRIOR ART) is a schematic view of a conventional means of attaching a soft strip to an attachment surface of an object;

FIG. 2 (PRIOR ART) is another schematic view of the soft strip attached to the attachment surface of the object;

FIG. 3 is an exploded view of an attachment-enabling jig according to a preferred embodiment of the present invention;

FIG. 4 is another exploded view of the attachment-enabling jig according to the preferred embodiment of the present invention;

FIG. 5 is a perspective view of the attachment-enabling jig when assembled according to the preferred embodiment of the present invention;

FIG. 6 is a schematic view of the attachment-enabling jig for positioning an object and a soft strip according to the preferred embodiment of the present invention;

FIG. 7 is a schematic view of the attachment-enabling jig for fixing in position an object and a soft strip according to the preferred embodiment of the present invention;

FIG. 8 is a schematic view of the attachment-enabling jig in operation according to the preferred embodiment of the present invention; and

FIG. 9 is another schematic view of the attachment-enabling jig in operation according to the preferred embodiment of the present invention.

### DETAILED DESCRIPTION

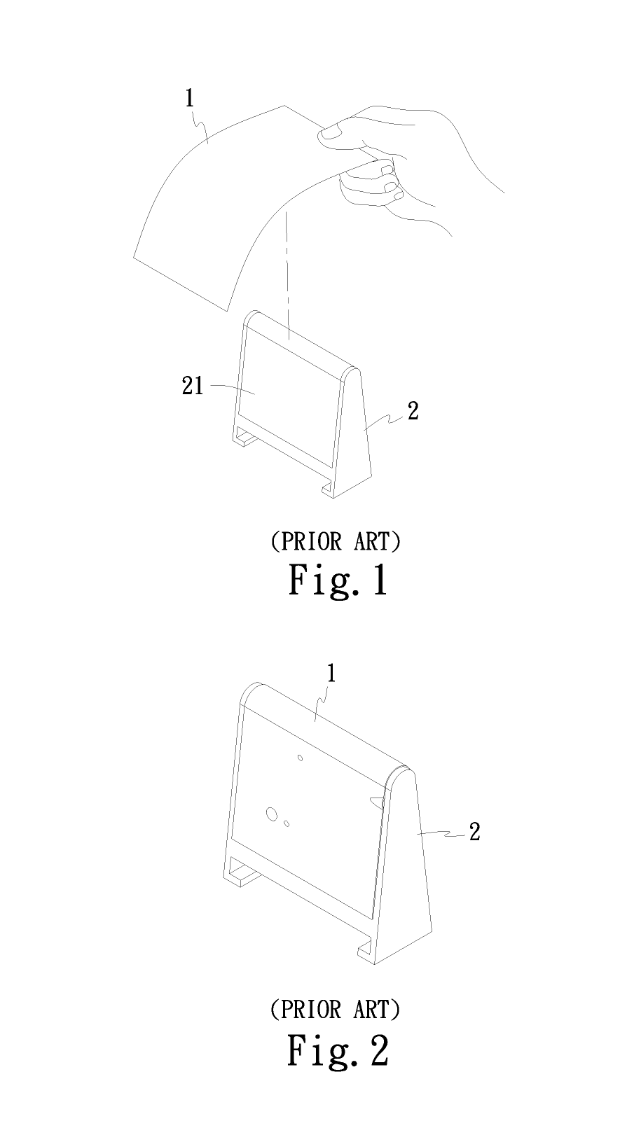

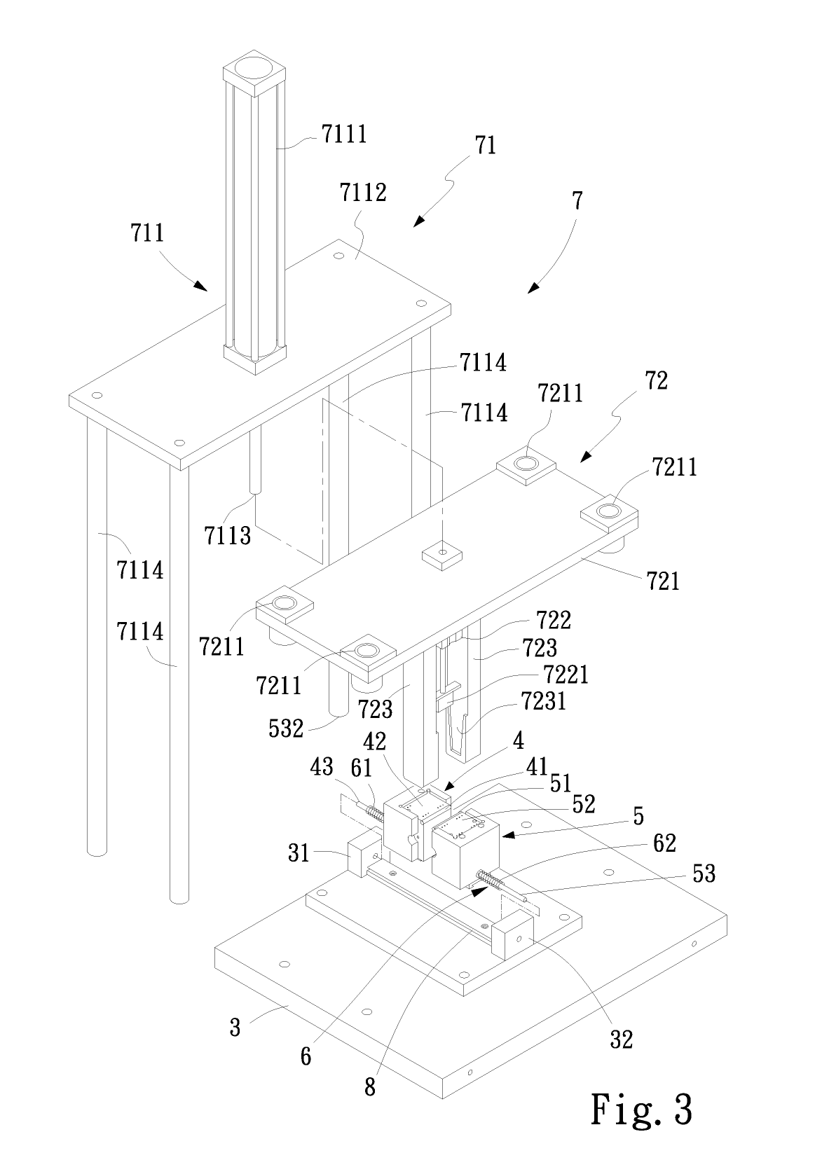

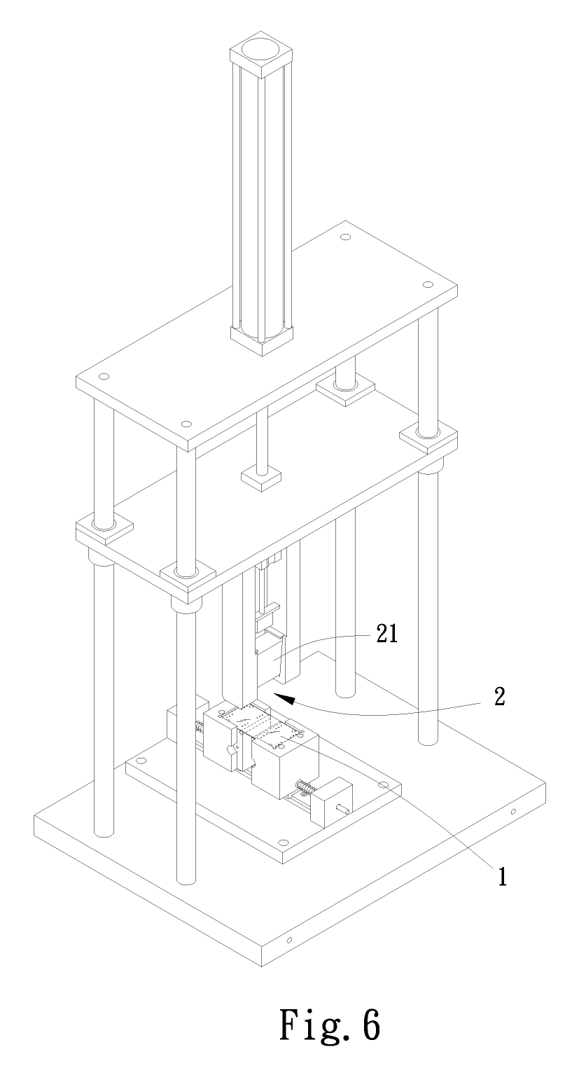

Referring to FIG. 3 and FIG. 6, there are shown an exploded view of an attachment-enabling jig according to a preferred embodiment of the present invention and a schematic view of an object 2 and a soft strip 1 positioned by means of the attachment-enabling jig according to the preferred embodiment of the present invention, respectively. As shown in the drawings, the attachment-enabling jig of the present invention is configured to attach the soft strip 1 (shown in FIGS. 1, 2, 6) to the attachment surface 21 of the object 2. The soft strip 1 is a rubber strip, a protective film, or a colored strip. Adhesive is applied to the soft strip 1 or the attachment surface 21 of the object 2 before the soft strip 1 is attached to the attachment surface 21 of the object 2. The attachment-enabling jig of the present invention comprises a base 3, a first carrying unit 4, a second carrying unit 5, a resilient unit 6, and an actuating unit 7. The first carrying unit 4 is disposed on the base 3. The first carrying unit 4 is movable across the base 3 in a first direction. The first carrying unit 4 is provided with a first roller 41 oriented perpendicular to the first direction. The second carrying unit 5 is disposed on the base 3 in a manner that the second carrying unit 5 corresponds in position to the first carrying unit 4 and is positioned proximate to the first roller 41. The second carrying unit 5 is provided with a second roller 51 corresponding in position to the first roller 41. The second carrying unit 5 is movable across the base 3 in the first direction. The second carrying unit 5 and the first carrying unit 4 together carry the soft strip 1 via one side thereof. The resilient unit 6 connects the first carrying unit 4 and the second carrying unit 5 and exerts, in the first direction, a resilient restoring force upon the first carrying unit 4 and the second carrying unit 5. Upon actuation, the first and second carrying units 4, 5 move in the first direction either away from each other or toward each other. For example, the first and second carrying units 4, 5 either move away from each other to thereby enable the resilient unit 6 to accumulate resilience energy or move toward each other upon release of the resilience energy from the resilient unit 6. The actuating unit 7 is disposed on the base 3. The actuating unit 7 holds the object 2 above the first roller 41 and the second roller 51 in a manner that the attachment surface 21 faces the first roller 41 and the second roller 51. Under the control of the actuating unit 7, the object 2 moves toward between the first roller 41 and the second roller 51 so as for the attachment surface 21 to be positioned between the first roller 41 and the second roller 51. As a result, both a force from the object 2 and the resilient restoring force from the resilient unit 6 are exerted upon the first carrying unit 4 and the second carrying unit 5, thereby causing the first carrying unit 4 and the second carrying unit 5 to move relative to each other in the first direction; meanwhile, with the first roller 41 and the second roller 51, the soft strip 1 is attached to the attachment surface 21 of the object 2 flatly. The first carrying unit 4 and the second carrying unit 5 move relatively slowly under the resilient restoring force, and thus the first and second rollers 41, 51 roll across the attachment surface 21 with seamless contact therebetween to ensure that the soft strip 1 can be attached to the attachment surface 21 flatly. Gas which is likely to be previously introduced to between the attachment surface 21 and the soft strip 1 is squeezes out therefrom by means of the seamless contact between the attachment surface 21 and the first and second rollers 41, 51 rolling thereon, thereby preventing the formation of bubbles from the gas. After the object 2 has come into contact with the soft strip 1 and moved to between the first and second rollers 41, 51, the soft strip 1 passes the first and second rollers 41, 51. Due to the circular profile of the first and second rollers 41, 51, the movement of the soft strip 1 into between the first and second rollers 41, 51 is always smooth. Likewise, due to the circular profile of the first and second rollers 41, 51, the first and second carrying units 4 push the soft strip 1 smoothly while the object 2 and the soft strip 1 are moving to between the first and second rollers 41, 51, and in consequence the soft strip 1 can be attached to the attachment surface 21 of the object 2 flatly.

The first and second carrying units 4, 5 each have a plurality of ventilating apertures 42, 52. The soft strip 1 is attracted to the ventilating apertures 42, 52 by suction; hence, the first and second carrying units 4, 5 can carry the soft strip 1 steadily. The number of the ventilating apertures 42, 52 is subject to changes as needed as long as the ventilating apertures 42, 52 are uniformly distributed on the first and second carrying units 4, 5 to generate uniform suction. The ventilating apertures 42, 52 serve a ventilation purpose, because the ventilating apertures 42, 52 communicate with a ventilating pump (not shown) through a passage (not shown) disposed inside the first and second carrying units 4, 5 and a pipe (not shown) provided outside thereof. With the suction being vertically generated by the ventilating apertures 42, 52, it is sufficient for the movement of the soft strip 1 to overcome the friction between the soft strip 1 and the first and second carrying units 4, 5 in order for the soft strip 1 to move, immediately after horizontal displacement, vertically to between the first and second rollers 41, 51 of the first and second carrying units 4, 5 together with the object 2. Furthermore, the friction can stretch the soft strip 1 slightly and thus keep the soft strip 1 flat throughout the course of the attachment thereof.

The resilient unit 6 comprises a first resilient element 61 and a second resilient element 62. The first resilient element 61 connects the base 3 and the first carrying unit 4 to thereby exert the resilient restoring force upon the first carrying unit 4 in the first direction. The second resilient element 62 connects the base 3 and the second carrying unit 5 to thereby exert the resilient restoring force upon the second carrying unit 5 in the first direction. The first and second carrying units 4, 5 move away from each other and thus compress the first and second resilient elements 61, 62 to thereby accumulate resilience energy therein. The subsequent release of the resilience energy from the first and second resilient elements 61, 62 enables the first and second resilient elements 61, 62 to drive the first and second carrying units 4, 5 to move toward each other. The carrying surfaces of the first and second carrying units 4, 5 carry the soft strip 1 through a surface thereof. The ventilating apertures 42, 52 are exposed from the carrying surfaces of the first and second carrying units 4, 5 to attract the soft strip 1 by suction.

The base 3 comprises a first stopping block 31 and a second stopping block 32. The first resilient element 61 connects the first stopping block 31 and the first carrying unit 4. The second resilient element 62 connects the second stopping block 32 and the second carrying unit 5.

The first carrying unit 4 and the second carrying unit 5 are further provided with a first guiding rod 43 and a second guiding rod 53, respectively. The first guiding rod 43 has one end connected to the first carrying unit 4 and another end penetrating the first resilient element 61 and the first stopping block 31. The second guiding rod 53 has one end connected to the second carrying unit 5 and another end penetrating the second resilient element 62 and the second stopping block 32. The first and second guiding rods 43, 53 serve to prevent the first and second resilient elements 61, 62 from deforming in a non-linear manner, respectively, while the first and second carrying units 4, 5 are moving away from each other or toward each other, and thus make sure the first and second resilient elements 61, 62 provide a linear force.

The attachment-enabling jig further comprises a guiding rail 8 which is disposed on the base 3 and in the first direction. The guiding rail 8 ensures that the first carrying unit 4 and the second carrying unit 5 can always move across the base 3 in the first direction.

The actuating unit 7 comprises an actuating component 71 and a holding component 72. The actuating component 71 comprises an actuating member 711 which is disposed above the first roller 41 and the second roller 51. The holding component 72 is coupled to the actuating member 711. The holding component 72 is configured to hold the object 2 above the first roller 41 and the second roller 51 in a manner that the attachment surface 21 of the object 2 faces the first roller 41 and the second roller 51. Under the control of the actuating member 711, the holding component 72 and the object 2 move to between the first roller 41 and the second roller 51.

The actuating member 711 comprises a retractable cylinder block 7111, a positioning platform 7112, and a plurality of guiding posts 7114 disposed on the base 3. The retractable cylinder block 7111, which is disposed above the positioning platform 7112, penetrates the positioning platform 7112 to form a driving end 7113 beneath the positioning platform 7112. The driving end 7113 is connected to the holding component 72. The retractable cylinder block 7111 controls the movement of the driving end 7113 and the holding component 72 in such a manner that the attachment surface 21 of the object 2 moves toward between the first roller 41 and the second roller 51.

The holding component 72 comprises a fixing platform 721, an auxiliary retractable cylinder block 722, and two fixing columns 723. The driving end 7113 of the retractable cylinder block 7111 of the actuating member 711 is fastened to or soldered to the fixing platform 721. The guiding posts 7114 penetrate a plurality of through-holes 7211 of the fixing platform 721, respectively. The auxiliary retractable cylinder block 722 and two said fixing columns 723 are fastened to or soldered to beneath the fixing platform 721. The auxiliary retractable cylinder block 722 is disposed between two said fixing columns 723. Two said fixing columns 723 have therein two receiving chambers 7231, respectively. Two said receiving chambers 7231 receive the object 2 from two sides thereof. A retractable end 7221 of the auxiliary retractable cylinder block 722 abuts against the object 2. The interval between the upper portions of two said fixing columns 723 is larger than that between the lower portions of two said fixing columns 723, such that the object 2 can be placed between two said receiving chambers 7231 from above. In addition, the bottom of each of two said receiving chambers 7231 matches two sides of the object 2 in shape, so as for the object 2 to be firmly fixed to the holding component 72; as a result, during the attachment process, the object 2 is free from vibration which might otherwise compromise the conforming rate of the attachment-enabling jig. Furthermore, two said fixing columns 723 are replaceable so as to suit two said receiving chambers 7231 of different shapes; hence, the holding component 72 is effective in holding the object 2 of different shapes.

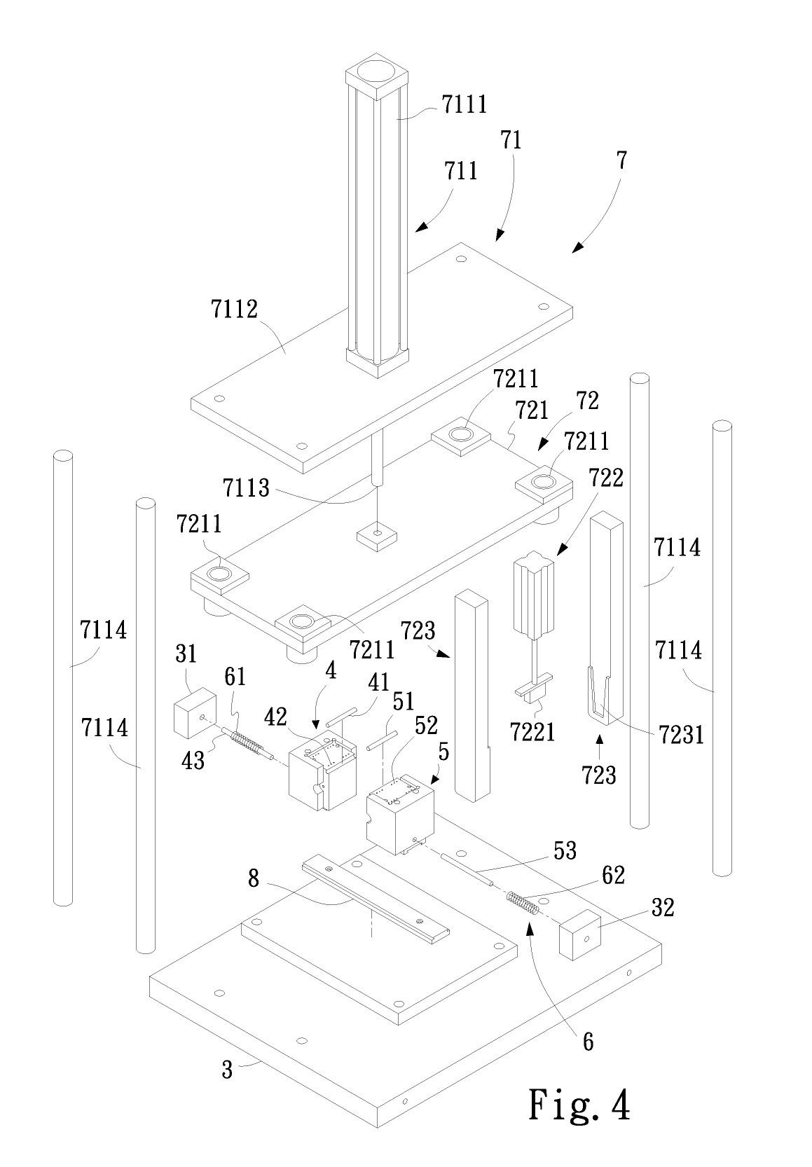

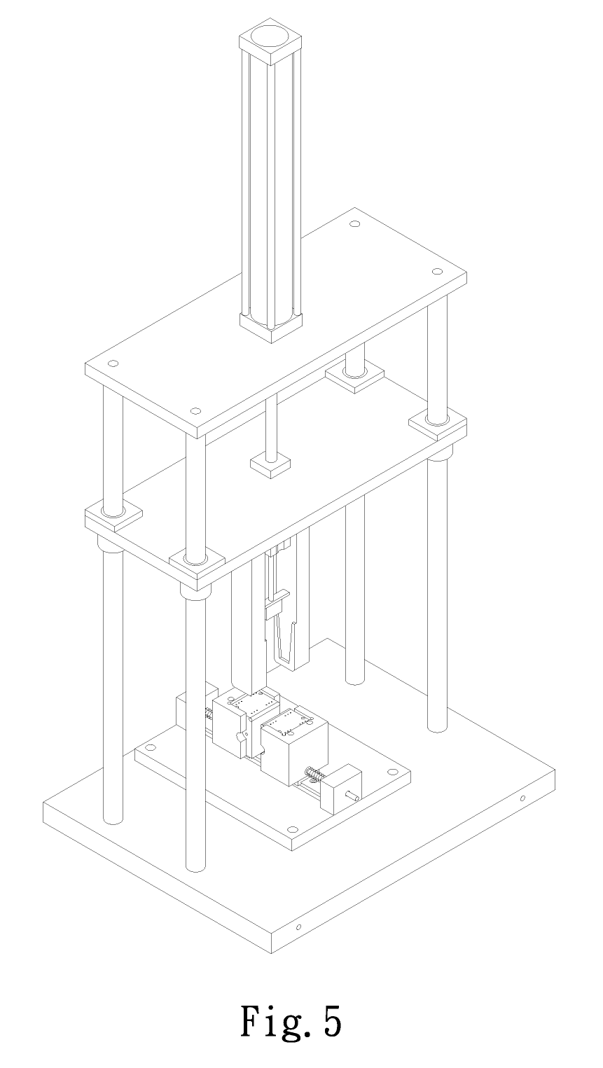

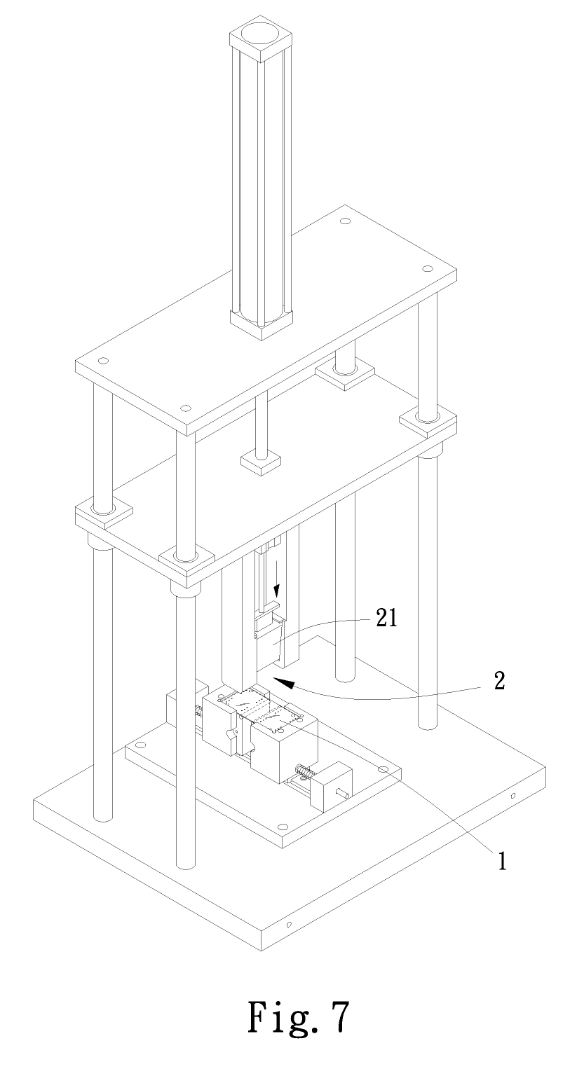

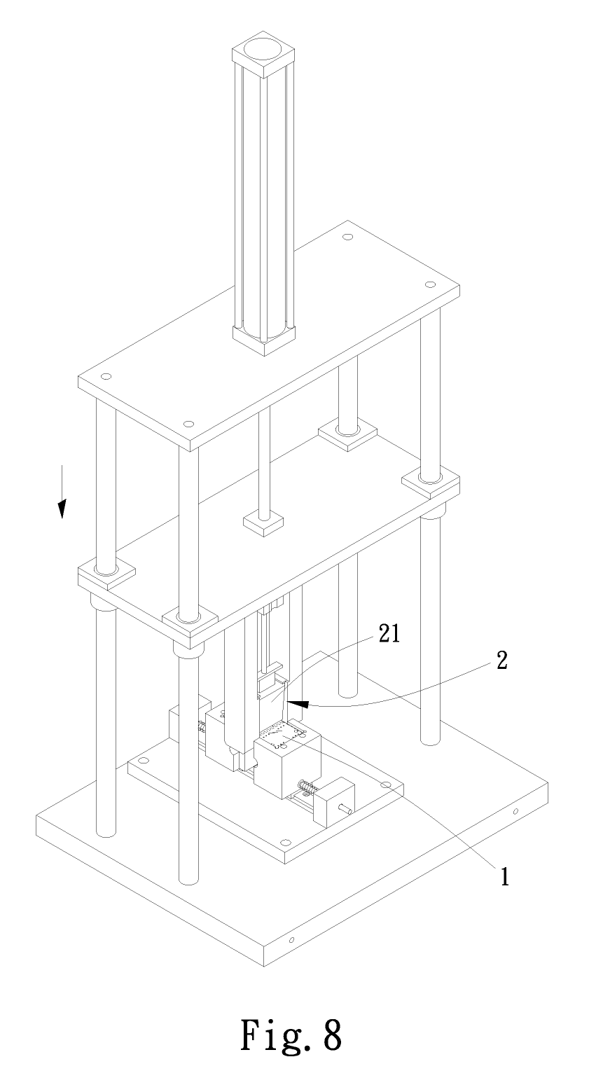

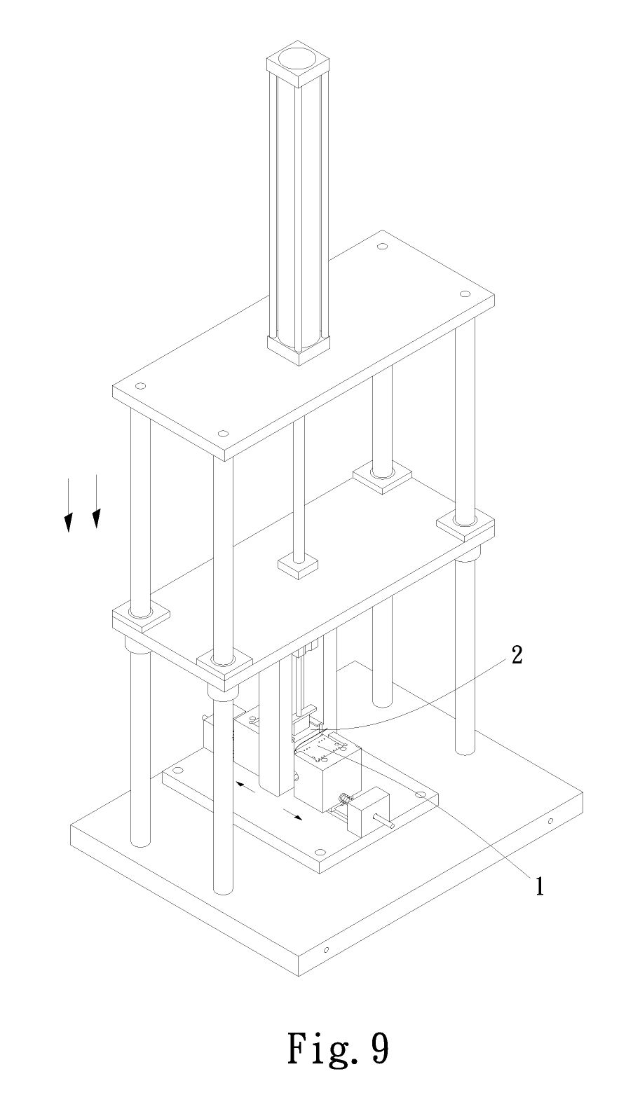

Referring to FIG. 6 through FIG. 9, there are shown schematic views of the attachment-enabling jig for positioning the object 2 and the soft strip 1 and the attachment-enabling jig in operation according to the preferred embodiment of the present invention, respectively. As shown in FIG. 4 and FIGS. 6-9, the soft strip 1 is straddlingly disposed between the first and second carrying units 4, 5, and then the object 2 is placed between two said receiving chambers 7231 from above. In this embodiment, the object 2 tapers downward, so do two said receiving chambers 7231. With the object 2 and the soft strip 1 in place, the retractable end 7221 of the auxiliary retractable cylinder block 722 extends and pushes the object 2 until the object 2 is firmly held by the holding component 72; meanwhile, the ventilating pump (not shown) is started, and thus the ventilating apertures 42, 52 begin to function. Ventilation effectuated by means of the ventilating apertures 42, 52 allows the soft strip 1 to be held in place by suction. Afterward, the driving end 7113 of the retractable cylinder block 7111 extends and pushes the holding component 72, so as to drive the object 2 toward the soft strip 1. In so doing, the object 2 and the soft strip 1 can be drawn closer to each other until the object 2 starts pushing the soft strip 1. With the suction being vertically generated by the ventilating apertures 42, 52, it is sufficient for the movement of the soft strip 1 to overcome the friction between the soft strip 1 and the first and second carrying units 4, 5 in order for the soft strip 1 to move, immediately after horizontal displacement, vertically to between the first and second rollers 41, 51 of the first and second carrying units 4, 5 together with the object 2. Furthermore, the friction can stretch the soft strip 1 slightly and thus keep the soft strip 1 flat throughout the course of the attachment thereof. Furthermore, the object 2 and the soft strip 1 move to between the first and second rollers 41, 51 to thereby push the first and second rollers 41, 51 of the first and second carrying units 4, 5, thereby separating the first and second carrying units 4, 5. Separation of the first and second carrying units 4, 5 is accompanied by accumulation of resilience energy in the first and second resilient elements 61, 62. Due to the resilience energy accumulated in the first and second resilient elements 61, 62, the first and second rollers 41, 51 press against the soft strip 1 smoothly, such that the soft strip 1 is attached to the attachment surface 21 of the object 2 flatly. Gas which is likely to be previously introduced to between the attachment surface 21 and the soft strip 1 is squeezes out therefrom during the aforesaid pressing process, thereby preventing the formation of bubbles from the gas.

The foregoing embodiment is provided to illustrate and disclose the technical features of the present invention so as to enable persons skilled in the art to understand the disclosure of the present invention and implement the present invention accordingly, and is not intended to be restrictive of the scope of the present invention. Hence, all equivalent modifications and replacements made to the foregoing embodiment without departing from the disclosure of the present invention should fall within the scope of the present invention as set forth in the appended claims. Accordingly, the scope of the protection for the present invention should be defined by the appended claims.

What is claimed is:

1. An attachment-enabling jig for attaching a soft strip to an attachment surface of an object, the attachment-enabling jig comprising:
a base;
a first carrying unit disposed on the base, movable across the base in a first direction, and provided with a first roller oriented perpendicular to the first direction;
a second carrying unit disposed on the base in a manner that the second carrying unit corresponds in position to the first carrying unit and is positioned proximate to the first roller, the second carrying unit being provided with a second roller corresponding in position to the first roller, the second carrying unit being movable across the base in the first direction, wherein the second carrying unit and the first carrying unit together carry the soft strip;
a resilient unit configured to connect the first carrying unit and the second carrying unit and exert, in the first direction, a resilient restoring force upon the first carrying unit and the second carrying unit; and
an actuating unit disposed on the base for holding the object above the first roller and the second roller in a manner that the attachment surface faces the first roller and the second roller, and enabling the object to move to between the first roller and the second roller so as for the attachment surface to be positioned between the first roller and the second roller, such that a force from the object and the resilient restoring force from the resilient unit are exerted upon the first carrying unit and the second carrying unit to thereby cause the first carrying unit and the second carrying unit to move relative to each other in the first direction, wherein the first roller and the second roller together attach the soft strip to the attachment surface flatly.

2. The attachment-enabling jig of claim 1, wherein the first and second carrying units each have a plurality of ventilating apertures for attracting the soft strip by suction.

3. The attachment-enabling jig of claim 1, wherein the resilient unit comprises a first resilient element and a second resilient element, the first resilient element connecting the base and the first carrying unit to thereby exert the resilient restoring force upon the first carrying unit in the first direction, and the second resilient element connecting the base and the second carrying unit to thereby exert the resilient restoring force upon the second carrying unit in the first direction.

4. The attachment-enabling jig of claim 3, wherein the base comprises a first stopping block and a second stopping block, allowing the first resilient element to connect the first stopping block and the first carrying unit, and allowing the second resilient element to connect the second stopping block and the second carrying unit.

5. The attachment-enabling jig of claim 4, wherein the first carrying unit and the second carrying unit are further provided with a first guiding rod and a second guiding rod, respectively, the first guiding rod having an end connected to the first carrying unit and another end penetrating the first resilient element and the first stopping block, and the second guiding rod having one end connected to the second carrying unit and another end penetrating the second resilient element and the second stopping block.

6. The attachment-enabling jig of claim 1, further comprising a guiding rail disposed on the base and in the first direction for ensuring that the first carrying unit and the second carrying unit are movably across the base in the first direction.

7. The attachment-enabling jig of claim 1, wherein the actuating unit comprises an actuating component and a holding component, the actuating component comprising an actuating member above the first roller and the second roller, and the holding component being coupled to the actuating member and configured to hold the object above the first roller and the second roller in a manner that the attachment surface faces the first roller and the second roller, wherein, under the control of the actuating member, the holding component and the object move to between the first roller and the second roller.

8. The attachment-enabling jig of claim 7, wherein the actuating member comprises a retractable cylinder block and a positioning platform, the retractable cylinder block being disposed above the positioning platform, penetrating the positioning platform to form a driving end beneath the positioning platform to be connected to the holding component, and controlling movement of the driving end and the holding component in such a manner that the attachment surface moves to between the first roller and the second roller.
